(19) United States
(12) Patent Application Publication
(10) Pub. No.: US 2018/0015649 A1
(43) Pub. Date: Jan. 18, 2018

(54) RAPID MANUFACTURING DETAIL ON RECEPTACLE AND MULTI-PURPOSE BUCKET LID

(71) Applicant: MEDWAY PLASTICS CORPORATION, Long Beach, CA (US)

(72) Inventor: Gerald A. Hutchinson, Austin, TX (US)

(21) Appl. No.: 15/646,932

(22) Filed: Jul. 11, 2017

Related U.S. Application Data
(60) Provisional application No. 62/361,437, filed on Jul. 12, 2016.
(60) Provisional application No. 62/361,447, filed on Jul. 12, 2016.

(51) Int. Cl. B29C 45/00; B65D 25/32; B65D 21/02; B29C 35/02; B65D 51/26; A47C 7/00; B29L 31/56

(52) U.S. Cl. CPC B29C 45/0053; B65D 51/26; B65D 25/32; A47C 7/00; B65D 21/0217; B29C 35/02; B29L 2031/565

(57) ABSTRACT

Some embodiments of the present disclosure include a mandrel system for creating a stamp on multiple receptacles. Some embodiments of the method include performing a step in the stamping process on a single receptacle while simultaneously performing another step in the stamping process on a second receptacle. The mandrel system may include a rotating mandrel system for rotating the mandrels that hold the receptacles to various positions, where the positions may be aligned with certain steps, such as heating, stamping, or cooling a portion of the receptacle. Some embodiments include a reversible lid including a fastening mechanism to fasten the lid in at least two configurations. In some embodiments, one side of the lid can be used to stack receptacles and the other side of the lid can be used to hold objects in slots and be used as a seat.

### CROSS-REFERENCE TO RELATED APPLICATIONS

This application claims the benefit of U.S. Provisional Application No. 62/361,447, filed Jul. 12, 2016, and titled “RECEPTACLE WITH MULTI-PURPOSE LID,” and U.S. Provisional Application No. 62/361,437, filed Jul. 12, 2016, and titled “THERMAL FORMED DETAIL ON RECEPTACLE.” Each of the foregoing applications is hereby incorporated herein by reference in its entirety.

### TECHNICAL FIELD

The current subject matter is directed to receptacles, in particular, using thermal forming to create detail on receptacles and a multipurpose lid.

### SUMMARY

The disclosure herein provides a thermal forming to create detail on receptacles, a multipurpose lid, and/or a plurality thereof. For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Some embodiments include a method for creating a detail on receptacles using a stamp of a mandrel system, the method comprising: loading, by the mandrel system, a first receptacle onto a first mandrel of the mandrel system; aligning, by an actuator of the mandrel system, the first receptacle with a heat pad such that desired portion of the first receptacle can be heated by the heat pad; heating, by the heat pad of the mandrel system, the desired portion of the first receptacle, wherein material of the heated portion of the first receptacle softens; stamping, by a stamp of the mandrel system, at least a subset of the heated portion of the first receptacle; and cooling, by a cooling system of the mandrel system, at least a subset of the stamped portion of the first receptacle, wherein during at least one of the aligning, heating, stamping, or cooling of the first receptacle, a second receptacle on a second mandrel of the mandrel system is simultaneously aligning, heating, stamping, or cooling.

Some embodiments include a method wherein the first and second receptacle are loaded into the first and second mandrel simultaneously.

Some embodiments include a method wherein the first receptacle is loaded into the first mandrel while the second receptacle that is already loaded onto the second mandrel is simultaneously being aligned, heated, stamped, or cooled.

Some embodiments include a method wherein aligning, by an actuator of the mandrel system, the first receptacle with a heat pad such that desired portion of the first receptacle can be heated by the heat pad includes rotating the first mandrel such that the rotated position of the first mandrel allows the heating pad to heat the desired portion of the first receptacle.

Some embodiments include a method wherein aligning, by an actuator of the mandrel system, the first receptacle with a heat pad such that desired portion of the first receptacle can be heated by the heat pad, heating, by the heat pad of the mandrel system, the desired portion of the first receptacle, wherein material of the heated portion of the first receptacle softens, stamping, by a stamp of the mandrel system, at least a subset of the heated portion of the first receptacle, and cooling, by a cooling system of the mandrel system, at least a subset of the stamped portion of the first receptacle occurs at a single position on the mandrel system.

Some embodiments include a method wherein at least two of aligning, by an actuator of the mandrel system, the first receptacle with a heat pad such that desired portion of the first receptacle can be heated by the heat pad, heating, by the heat pad of the mandrel system, the desired portion of the first receptacle, wherein material of the heated portion of the first receptacle softens, stamping, by a stamp of the mandrel system, at least a subset of the heated portion of the first receptacle, or cooling, by a cooling system of the mandrel system, at least a subset of the stamped portion of the first receptacle occurs at different positions on the mandrel system.

Some embodiments include a method further comprising: before stamping, by a stamp of the mandrel system, at least a subset of the heated portion of the first receptacle, rotating the mandrel system such that the first mandrel moves from a position for heating by the heating pad of the mandrel system to a position for stamping by the stamp of the mandrel system; and before cooling, by a cooling system of the mandrel system, at least a subset of the stamped portion of the first receptacle, rotating the mandrel system such that the first mandrel moves from a position for stamping by the stamp of the mandrel system to a position for cooling by the cooling system of the mandrel system.

Some embodiments include a method wherein the first mandrel is configured such that a draw exists between the first receptacle and the first mandrel when the first receptacle is placed on the first mandrel of the mandrel system such that an air gap is formed, and wherein the first mandrel includes a vacuum configured to extract gas between the first mandrel and the first receptacle.

Some embodiments include a method wherein stamping, by a stamp of the mandrel system, at least a subset of the heated portion of the first receptacle includes stamping the at least a subset of the heated portion of the first receptacle such that the at least a subset of the heated portion of the first receptacle is substantially flush to another portion of the first receptacle.

Some embodiments include a mandrel system for stamping receptacles using concurrent processing, the mandrel system comprising: a first mandrel configured to: load and unload a first receptacle; and move to at least two positions of the mandrel system; a second mandrel configured to: load and unload a second receptacle; and move to the at least two positions of the mandrel system; a heat pad configured to heat a portion of the first and second receptacle, wherein material of the heated portion of the first and the second receptacle softens; a stamp configured to stamp at least a subset of the heated portion of the first and second receptacle; and a cooling system configured to cool at least a subset of the stamped portion of the first and second receptacle; wherein the first mandrel is configured to be disposed at a first position of the mandrel system while the second mandrel is configured to be disposed at a second position of the mandrel system; wherein at least two of the heat pad, the stamp, or the cooling system are positioned in substantial proximity of the first position and second position of the mandrel system, respectively.

Some embodiments include a system wherein the heat pad includes a first heat pad and a second heat pad disposed at different positions of the mandrel system.

Some embodiments include a system wherein the cooling system includes a first cooling system and a second cooling system disposed at different positions of the mandrel system.

Some embodiments include a system wherein the stamp includes a first stamp configured to stamp a design and a second stamp configured to stamp a shield, the first and second stamp disposed at different positions of the mandrel system.

Some embodiments include a system wherein the first receptacle is unloaded on a first position of the mandrel system, and a second receptacle is loaded onto the first position of the mandrel system.

Some embodiments include a system wherein the cooling system of the mandrel system is configured to transfer heat by changing a temperature of at least a portion of a mandrel.

Some embodiments include a system further comprising a support structure configured to support the first receptacle for stamping, by a stamp of the mandrel system, the at least a subset of the heated portion of the first receptacle.

Some embodiments include a reversible lid for a receptacle, the reversible lid comprising: a bottom portion configured to support receptacle stacking such that another receptacle can stack on the bottom portion when the reversible lid is fastened to the receptacle where the bottom portion is facing away from the receptacle; a top portion; and a fastening mechanism is configured to fasten the reversible lid to the receptacle in at least two configurations: where the bottom portion is facing away from the receptacle and where the bottom portion is facing toward the receptacle.

Some embodiments include a reversible lid wherein the top portion includes one or more slots integrated with the top portion and configured to hold objects in the one or more slots.

Some embodiments include a reversible lid wherein top portion is a substantially semispherical shape and includes material softer than the material of the bottom portion, wherein the top portion provide a seat for an individual.

Some embodiments include a reversible lid wherein at least a portion of the reversible lid is created by co-injection technology.

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

### DESCRIPTION OF THE DRAWINGS

FIG. 1 is a front perspective view of a bucket according to some embodiments.

FIG. 2 is a front perspective view of a bucket inserted into the mandrel according to some embodiments.

FIG. 3A is a front perspective view of a mandrel system heating the side of the bucket according to some embodiments.

FIG. 3B is a front perspective view of a mandrel system stamping the side of the bucket according to some embodiments.

FIG. 3C is a front perspective view of a mandrel system stamping the side of the bucket inside of a cross-section of the bucket according to some embodiments.

FIG. 4A is a front perspective view of a rapid manufacturing mandrel system according to some embodiments.

FIG. 4B is a front perspective view of a rapid manufacturing square mandrel system according to some embodiments.

FIG. 4C is a front perspective view of a rapid manufacturing serial mandrel system according to some embodiments.

FIG. 5A is a front perspective view of a rapid manufacturing mandrel system with the stamp, the cooling system, and the heat pad on different positions of the mandrel system according to some embodiments.

FIG. 5B is a front perspective view of a rapid manufacturing mandrel system with two heat pads and two cooling systems on different positions of the mandrel system according to some embodiments.

FIG. 5C is a front perspective view of a rapid manufacturing mandrel system where the bucket is fed and removed at a single position according to some embodiments.

FIG. 5D is a front perspective view of a rapid manufacturing mandrel system where multiple stamps are applied according to some embodiments.

FIG. 6 is a perspective view of a conventional lid for a bucket.

FIG. 7A is a front perspective view of a bucket with a lid that serves as a seat according to some embodiments.

FIG. 7B is a front perspective view of a bucket with an individual sitting on the lid according to some embodiments.

FIG. 7C is a front perspective view of a bucket with multiple individuals sitting on the lid according to some embodiments.

FIG. 8 is a front perspective view of the bucket with a lid that can be used to hold items according to some embodiments.

FIG. 9A is a front perspective view of the bucket with a lid that can be partially used as a seat and partially used to hold items according to some embodiments.

FIG. 9B is a front perspective view of an individual sitting on the lid and placing items into slots on the lid according to some embodiments.

FIG. 10A is a cross-sectional view of the bucket with the reversible lid according to some embodiments.

FIG. 10B is a cross-sectional view of buckets stacked on top of the reversible lid according to some embodiments.

### DETAILED DESCRIPTION

Although several embodiments, examples, and illustrations are disclosed below, it will be understood by those of ordinary skill in the art that the inventions described herein extend beyond the specifically disclosed embodiments, examples, and illustrations and includes other uses of the inventions and obvious modifications and equivalents thereof. Embodiments of the inventions are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

Receptacles have become a popular medium of transporting goods. Labels are placed on receptacles to inform users of important information, such as goods carried, the brand, destination and source address, etc. Labels have been printed or glued onto the sides of the receptacles. However, receptacles are commonly nested together and such labels have been prone to tear or fold. Furthermore, shields have been designed over the labels. However, shields generally bulge out from the diameter of the bucket and thus cause difficulty in nesting properly. Furthermore, creating these labels and shields have been time consuming and costly. Therefore, there is a need to create a labeling mechanism that is fast, affordable, and effectively allow for proper nesting.

It should be understood that the present disclosure generally relates to a bucket. The bucket can be a bucket of standard size, such as a 5 gallon bucket that is 11.91″ dia.×14.50″ high×10.33″ dia. with a wall thickness of 0.075″+/−.005″, or a 5 gallon bucket that is 13″ in depth, 14.5″ in height, 12″ in diameter, and 13″ in width. However, any sized bucket, standard or non-standard sized, is appreciated. Furthermore, any structure (for example, a container, crate, bottle) that may provide for storage and receipt of a fluid, solid, or other material which a user wishes to store or transport has been contemplated. The present disclosure is in no way limited to the embodiment disclosed herein. However, for ease of understanding and to provide at least one preferred exemplary embodiment, a bucket system is described. Furthermore, although the embodiments disclose storing liquids in the bucket, it is understood that the present disclosure is not limited to the storage of liquids but may be utilized with any material to be stored.

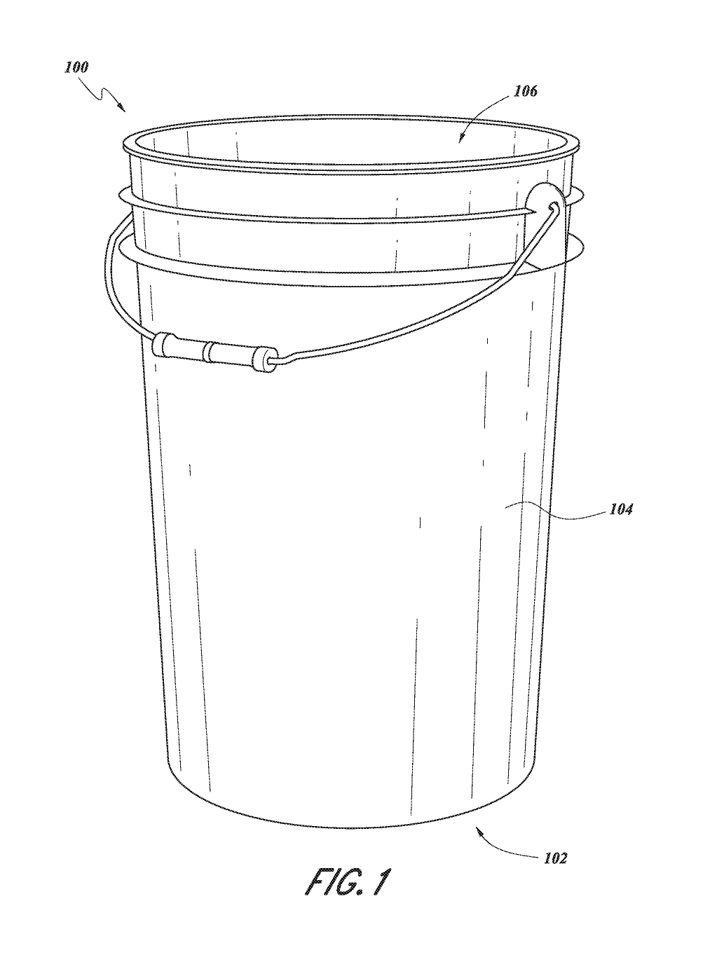

Turning now to the Figures where like numbers represent like elements, FIGS. 1-3 illustrate several views of the mandrel system for creating such labels on the bucket. FIG. 1 is a first front perspective view of a bucket according to some embodiments.

As illustrated in FIG. 1, the bucket 100 may have at least a bottom portion 102 which may be integrally attached to at least a side wall portion 104. FIG. 1 illustrates the side wall portion 104 to be cylindrical in shape. However, it is appreciated by those of ordinary skill in the art, the side wall portion 104 may have a plurality of different structures including generally circular, generally elliptical, generally rectangular, and/or generally square shape, generally trapezoidal shape, and the like. Additionally, with the plurality of different shapes and sizes of the bucket 100, the side wall portion 104 may have a plurality of sides (not shown). The side wall portion 104 may vary depending on the size and shape of the bucket 100 structure.

In some embodiments, a side wall portion 104 can extend and/or protrude from the bottom portion 102. In certain embodiments, a base wall portion 204 can extend and/or protrude from the bottom portion 102 at an angle. An angle measured from the inner surface of the bottom portion 102 and the inner surface of the side wall portion 104 can be greater than 90°. In certain embodiments, the angle measured from the inner surface of the side wall portion 104 and the inner surface of the bottom portion 102 can be about 0°, about 10°, about 20°, about 30°, about 40°, about 50°, about 60°, about 70°, about 80°, about 90°, about 100°, about 110°, about 120°, about 130°, about 140°, about 150°, about 160°, about 170°, about 180°, or within a range defined by any of the two above-identified values.

In FIG. 1, the side wall portion 104 takes up the entire area of the bottom portion 102 of the bucket 100. The side wall portion 104, in the embodiment of FIG. 1, represents the largest viewing surface to the individual.

The side wall portion 104 may also be integrally attached to a top area 106. The top area 106 may contain an opening for allowing an individual to place liquids, solids, or other items for storage inside the bucket 100. It is recognized that there may not be an opening, or the opening may be located in a different area besides the top area 106. Furthermore, the opening can be as wide as the diameter or the width of the side wall portion 104, or may be a different width or diameter. Furthermore, the opening may alternatively come together in a flask like configuration.

In certain embodiments, the height of an elongated portion of side wall portion 104, which extends from the circumference of the bottom portion thereof can be about 10 cm, about 11 cm, about 12 cm, about 13 cm, about 14 cm, about 15 cm, about 16 cm, about 17 cm, about 18 cm, about 19 cm, about 2 cm, about 21 cm, about 22 cm, about 23 cm, about 24 cm, about 25 cm, about 26 cm, about 27 cm, about 28 cm, about 29 cm, about 30 cm, about 31 cm, about 32 cm, about 33 cm, about 34 cm, about 35 cm, about 36 cm, about 37 cm, about 38 cm, about 39 cm, about 40 cm, about 41 cm, about 42 cm, about 43 cm, about 44 cm, about 45 cm, about 46 cm, about 47 cm, about 48 cm, about 49 cm, about 50 cm, about 60 cm, about 70 cm, about 80 cm, about 90 cm, about 100 cm, and/or within a range defined by two of the aforementioned values, and the like.

In some embodiments, a thickness of a side wall portion 104 and/or the bottom portion 102 can be about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 2 mm, about 3 mm, about 4 mm, about 5 mm, about 6 mm, about 7 mm, about 8 mm, about 9 mm, about 1 cm, about 1.1 cm, about 1.2 cm, about 1.3 cm, about 1.4 cm, about 1.5 cm, about 1.6 cm, about 1.7 cm, about 1.8 cm, about 1.9 cm, about 2 cm, about 2.1 cm, about 2.2 cm, about 2.3 cm, about 2.4 cm, about 2.5 cm, about 2.6 cm, about 2.7 cm, about 2.8 cm, about 2.9 cm, about 3 cm, about 4 cm, about 5 cm, about 6 cm, about 7 cm, about 8 cm, about 9 cm, about 10 cm, and/or within a range defined by any two of the aforementioned values, and the like.

### Mandrel and the Receptacle

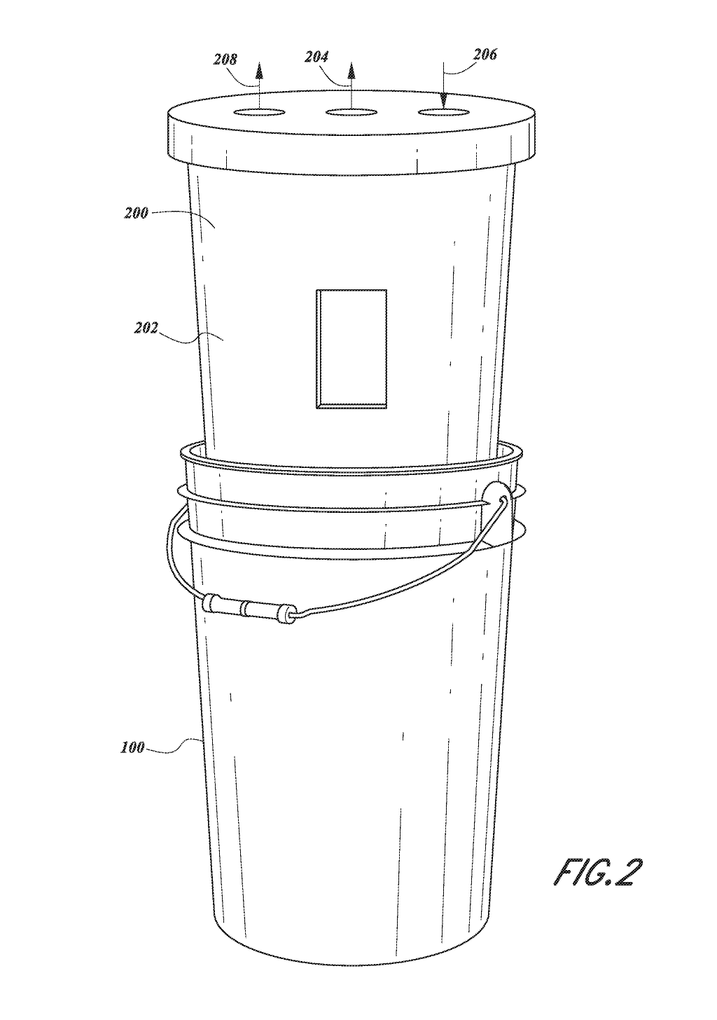

FIG. 2 is a first front perspective view of a bucket 100 inserted into the mandrel 200 according to some embodiments. The bucket 100 may be machine-fed, manually inserted, or a mixed process. The mandrel 200 may hold and support the bucket 100 on its own, or may have some additional support structure, such as a clamping mechanism, to keep the bucket 100 on the mandrel 200. The mandrel 200 may be as long as the bucket 100, or may be shorter. The mandrel 200 may have the same draw angle of the bucket 100 or may be any other shape or size.

The mandrel 200 may contain a recess 202. This embodiment shows the recess 202 to be rectangular on the cylindrical side of the mandrel. However, it is appreciated that the recess 202 can be of a variety of shapes and sizes, and there may be a plurality of recesses 202. The recess 202 may be a depressed area on the surface of the mandrel 200. However, it is appreciated that other shapes and forms may form on the mandrel 200. For example, the recess 202 may instead be a bulge or a protrusion, or a combination of budges and/or recesses. Therefore, the mandrel 200 can place a variety of different types of details on the bucket 100. The recess 202 may include a groove, a slot, a cutout, a void, an impression, and the like.

The mandrel 200 may have a vacuum 204 or be configured to allow a vacuum 204 to be attached. The vacuum 204 may be placed anywhere on the mandrel 200 that allows for the suction of gas between the mandrel 200 and the bucket 100. The suction of gas may allow the portion of the bucket 100 to form to the recess 202, discussed in further detail below. In other embodiments, the vacuum 204 may allow for the suction of non-gas matter. The vacuum 204 hole may be located in the recess when creating the suction. However, it is appreciated that the vacuum 204 hole may be located in many other locations on the bucket 100. For example, there may be more than one hole for the vacuum 204 (the vacuum 204 hole may be placed near the bottom portion 102 of the bucket 100). The vacuum 204 may pull air to create a vacuum between the mandrel 200 and the bucket 100. The vacuum 204 may be turned on periodically, by a set schedule, depending on the state of the bucket 100 and the mandrel 200, or at the manual input of a user.

The mandrel 200 may have a cooling system. The cooling system may be created with an input 206 and/or output 208 of a cold substance. For example, cold water may flow into the input 206 when it is desired to cool a heated portion of the bucket 100. However, other gases and/or liquids can be used. Furthermore, other ways of cooling are appreciated. For example, chemicals may be used to convert from gas to liquid and back again, using a transfer of heat from the air inside the mandrel 200 and near the bucket to external to the mandrel 200. The amount of cooling may be a function of a bucket's diameter, the material the bucket 100 is made from, the size of the labeling area, the depth of the stamp or the amount of heat applied, and other factors that may be relevant to cooling.

Although FIG. 2 shows a single bucket 100 inserted into a single mandrel 200, it is appreciated that multiple buckets 100 may be inserted into multiple mandrels 200 at the same time.

Although not shown in FIG. 2, the side wall portion 104 of the bucket 100 may have a draw angle. This draw angle helps to create an air gap between the bucket 100 and the mandrel 200. This allows for more effective detaching of the bucket 100 from the mandrel 200.

### Stamping the Detail on the Receptacle

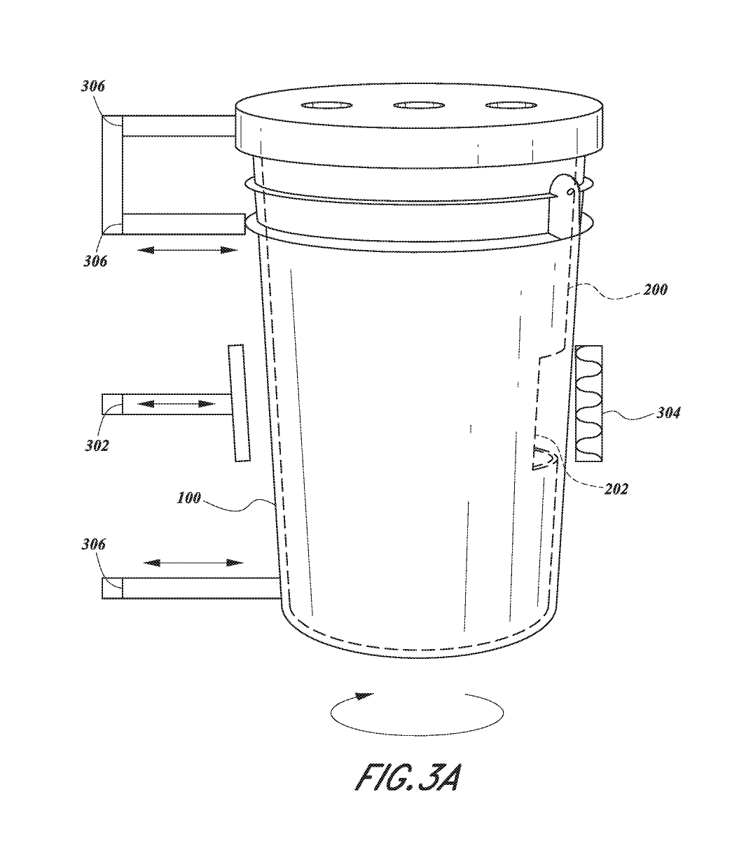

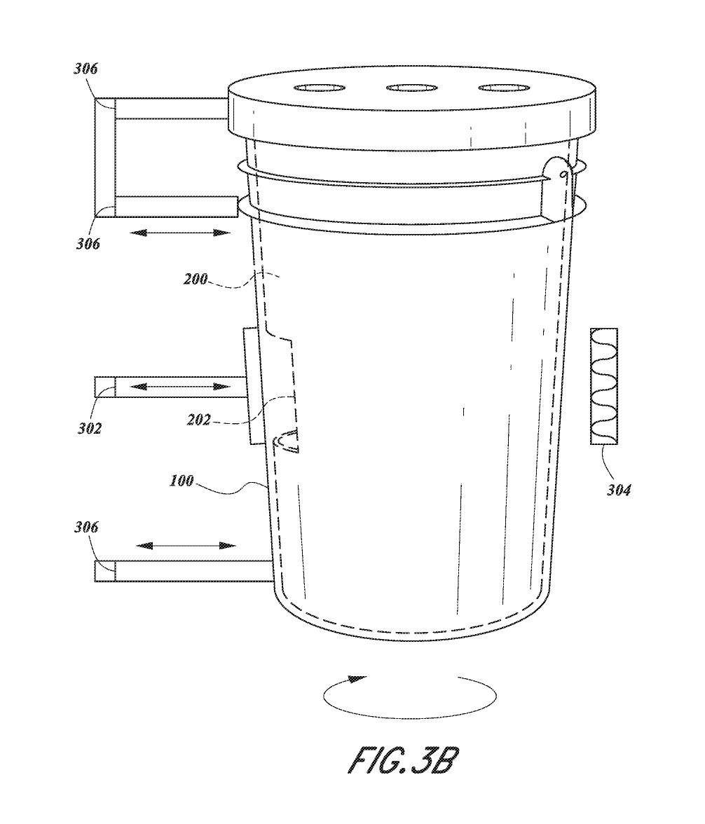

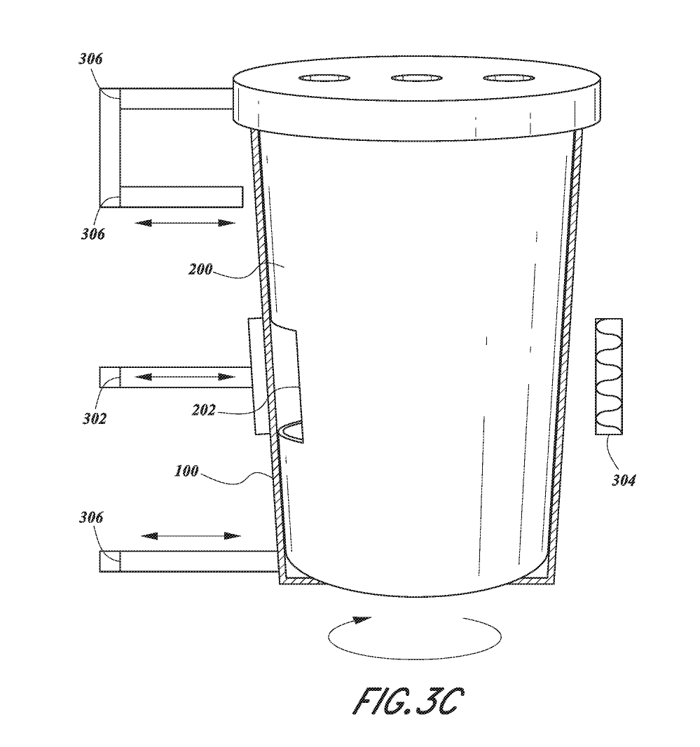

FIG. 3A is a front perspective view of a mandrel system heating the side of the bucket according to some embodiments. FIG. 3B is a front perspective view of a mandrel system stamping the side of the bucket according to some embodiments. FIG. 3C is a front perspective view of a mandrel system stamping the side of the bucket inside of a cross-section of the bucket according to some embodiments.

In the example of FIG. 3A, a heat pad 304 is placed at the top of the system. The heat pad 304 is placed on the side of the bucket 100. Heating the side of the bucket 100 may make the material of the bucket 100 softer to allow the stamp 302 to stamp the side of the bucket 100 with the desired detail. Although this example shows a single heat pad 304, there may be more than one. Furthermore, the heat pad 304 may be placed in different areas of the system that allows a portion of the bucket 100 to be heated. Furthermore, other ways of making the surface of the bucket 100 soft are appreciated. In some embodiments, the heat pad 304 is applied on other areas of the bucket 100 besides the side wall portion 104.

The amount of heat applied by the heat pad 304 may depend on several factors. For example, it may depend on the material that the bucket 100 is made of, the thickness of the bucket 100, the size of the labeling area, the even distribution of heat on the heat pad 304, the contour of the surface of the bucket 100 at which the heat may be applied, or other factors relevant to making the surface of the bucket 100 ready for stamping. Standard bucket thickness is 30-50 mils and the system may be customized for this thickness. In other embodiments, the system may measure parameters or have an input for parameters used when determining the amount of heat to apply. The mandrel 200 may have a similar shape to the bucket 100 to preserve the dimensional aspects of the bucket 100 while heat is concentrated on the area to be formed.

The heating pad 304 may be applied to just a portion of the bucket 100 that may be stamped. However, it is appreciated that the heating pad 304 may apply heat on a smaller or larger portion of the bucket 100 at a time. Furthermore, the heating pad 304 may not apply heat to the full area to be stamped at once, but may heat certain portions at different times, which collectively heat a larger stamping area. The heating pad 304 may also heat a portion while a different portion is simultaneously being stamped.

FIG. 3A shows a stamp 302 stamping the side wall portion 104 of the bucket 100 after heat has been applied and is ready to be stamped or thermoformed to produce the detail. This stamp 302 may be applied on the heated portion of the bucket 100. This may create the design, label, mold, or anything else that may be useful to place on the side of the bucket 100. The stamp 302 may be placed on a part of the bucket 100 that is behind the recess 202. This may allow the stamp 302 to place objects onto the bucket 100, the bucket 100 may fall behind the recess, and the side of the bucket 100 may still remain flush or even recessed beyond the diameter of the bucket 100. Although FIG. 3A show a single stamp 302, there may be more than one stamp 302, the stamp 302 may be placed in different areas of the bucket 100, and the stamp 302 shape may be different from that described in FIG. 3.

The stamp 302 may thermoform a design, a design with a shield, or a shield that may hold a design. The stamp 302 may thermoform in one step or thermoform in multiple steps. The shield may be attached in a downstream operation, by heat, chemical bonding, or mechanical bonding. The stamp 302 may be of the same shape and size as the recess 202 and/or the heating pad 304. However, the stamp 302, the recess 202, and the heating pad 304 may be different in shape and size.

The system may rotate the bucket 100 to move the heated portion of the bucket 100 to where the stamping may occur. The rotating of the bucket 100 may be performed by a hydraulic or pneumatic actuator, or by other means. A pneumatic actuator may not be as strong and may use a servo motor for functions in the machine, while a hydraulic actuator may provide more strength and speed to the rotation.

FIG. 3A shows three supports 306. The three supports 306 may be placed on the rim of the bucket 100, the side of the bucket 100, and the bottom end of the bucket 100. There may be more or less supports 306 to support the bucket 100. Because the bucket 100 may be long, these supports help to keep the bucket 100 in place. The supports 306 may help to stabilize the bucket 100 when pressing, stamping, rotating, inserting, and removing from the mandrel 200. In other embodiments, there are more or less supports 306, or no supports 306.

In some embodiments, the mandrel can be rotated to align the bucket to the heat pad, the cooling system, and/or the stamp.

### Rapid Manufacturing Detail on the Receptacle

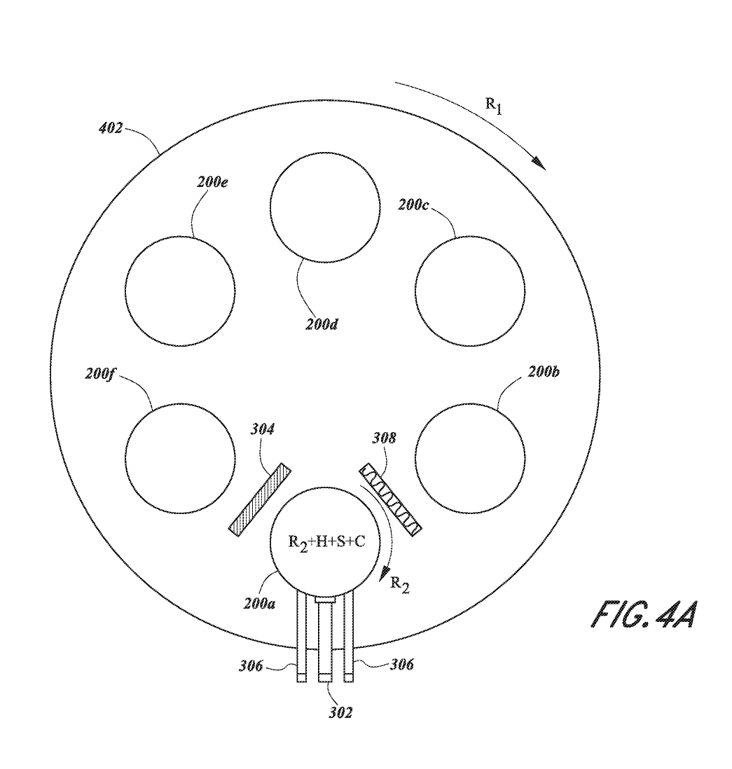

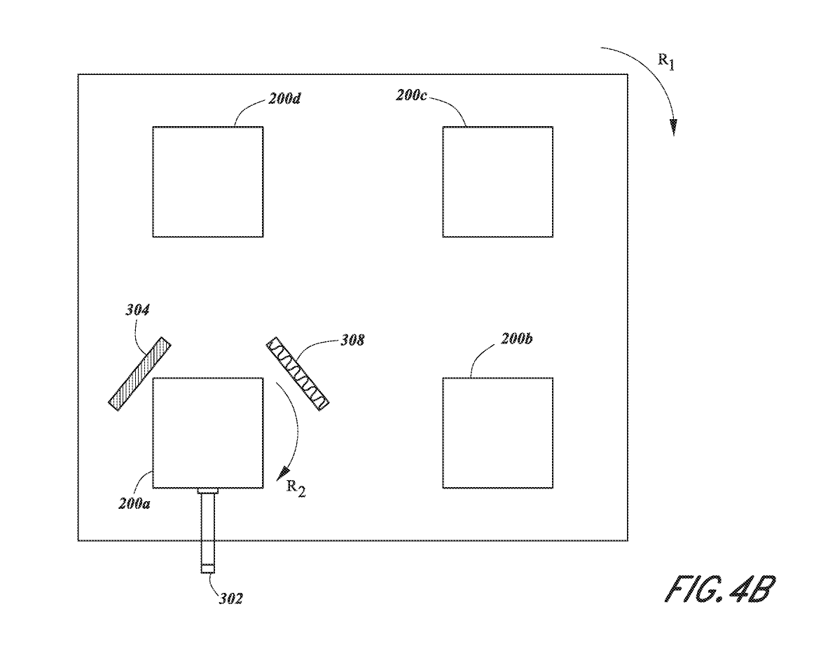

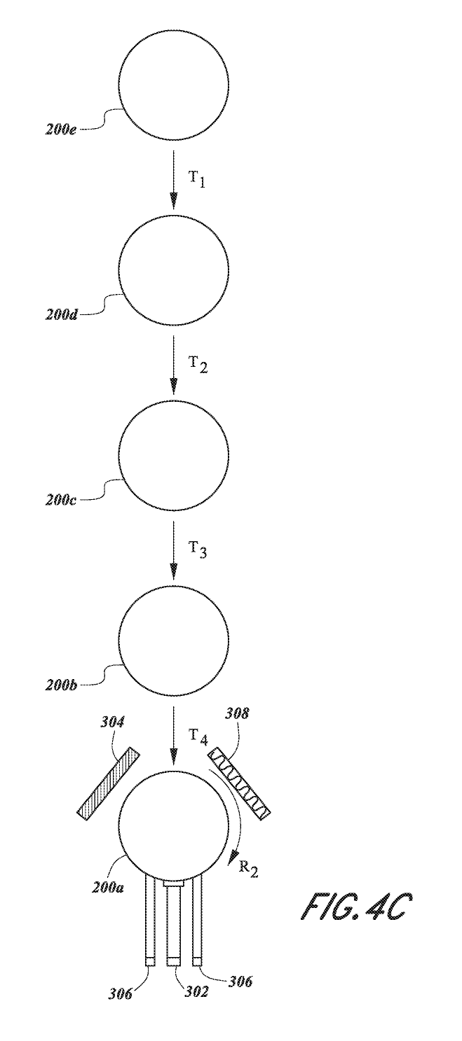

FIG. 4A is a front perspective view of a rapid manufacturing mandrel system according to some embodiments. The rapid manufacturing mandrel system 402 may be in a large cylindrical shape. However, it is appreciated that any other shapes and sizes may be applicable that may hold a plurality of mandrels 200A-200F.

The rapid manufacturing mandrel system 402 may hold a plurality of mandrels 200A-200F. As shown in FIG. 4A, mandrel 200A is placed between the heating pad 304 and the supports 306 with the stamp 302. Here, the mandrel 200A may be first supported by the supports 306, heated by the heating pad 304, rotated by the mandrel 200A, and stamped by the stamp 302. Then, the rapid manufacturing mandrel system 402 rotates, and a different mandrel 200B may be placed between the heating pad 304 and the supports 306 with the stamp 302. Then, the process of heating and stamping may be conducted on a different mandrel 200B while the prior heated and stamped mandrel 200A may be cooling.

This rapid manufacturing mandrel system 402 may save overall time of the heating and stamping process. For example, let's say the heating process time is “H”, the stamping process time is “S”, the cooling process time is “C”, the bucket loading time is “L”, the bucket unloading time is “U”, the rotating of the rapid manufacturing mandrel system 402 time is “R₁”, the rotating of the individual mandrels is “R₂”. An estimate of the time it may take to stamp six buckets 100 by the embodiment in FIG. 3A may be:

6L+6H+6R₂+6S+6C+6U+5R₁

This is because each bucket 200A-200F may have to be loaded, heated, rotated, stamped, cooled, and unloaded before the next bucket can be loaded, heated, rotated, stamped, cooled, and unloaded.

In some embodiments, an estimate of the time it may take the rapid manufacturing mandrel system 402 of FIG. 4A to stamp six buckets 200A-200F as described in the embodiment of FIG. 4A may be about:

L+6H+6R₂+6S+6C+U+5R₁

This is because all six buckets 200A-200F may be loaded and unloaded at the same time reducing the loading and unloading times to (L+U). In the embodiment of FIG. 4A, each bucket may be heated, stamped, and cooled separately (6H+6S) and each mandrel rotated (6R₂) to the next bucket to be heated, stamped, and cooled. However, other embodiments are appreciated where multiple buckets 200A-200F are heated and stamped simultaneously. In some embodiments, the cooling period may be reduced to the cooling period of the last bucket 200F stamped because the other buckets 200A-200E may have already been cooling because they were stamped earlier (C). The time to rotate the buckets 200A-200F around the rapid manufacturing mandrel system 402 is added (5R₁). Therefore, the loading and unloading times of the buckets are greatly reduced.

In some embodiments, the mandrel system aligns the bucket for the heating pad, the cooling system, and/or the stamp. The alignment can occur by rotating individual mandrels. In some embodiments, the mandrel system rotates. The mandrel system can rotate such that an alignment of one portion of the mandrel system aligns the bucket for other portions of the mandrel system. For example, a bucket may be aligned for the heat pad. As the mandrel system rotates, the mandrel is moved to the stamping portion of the mandrel system. Because the bucket was aligned for the heat pad, the bucket can also be aligned for the stamp. Accordingly, the time required may only be a single rotation of the mandrel at the beginning, to align the bucket to one portion of the rotating mandrel system.

FIG. 4B is a front perspective view of a rapid manufacturing square mandrel system according to some embodiments. The rapid manufacturing mandrel system can be of a different shape or size. For example, the rapid manufacturing mandrel system can be a square, a circle, triangle, rectangle, polygon, parallelogram, and the like. Furthermore, the mandrels can be of a different shape or size (e.g. square, a circle, triangle, rectangle, polygon, parallelogram, and the like). For example, the mandrels 200A, 200B, 200C, 200D are square.

FIG. 4C is a front perspective view of a rapid manufacturing serial mandrel system according to some embodiments. The rapid manufacturing mandrel system may include different paths for moving the mandrel at various positions for cooling, heating, and/or stamping. For example, the rapid manufacturing mandrel system may move the mandrel serially in one direction. For example, the mandrels 200B, 200C, 200D, and 200E move in a serial downward direction until the mandrels are at the position of mandrel 200A, where the loading, unloading, heating, cooling, and/or stamping may occur. In some embodiments, the path for moving the mandrel may be rotational, in one direction, in the X-Y direction, in the X-Y-Z direction, and/or a combination. In some embodiments, the mandrels are moved to different positions such that at least some of the steps for loading, unloading, heating, cooling, and/or stamping can be performed on one receptacle simultaneously to loading, unloading, heating, cooling, and/or stamping of another receptacle.

### Rapid Manufacturing Efficiencies

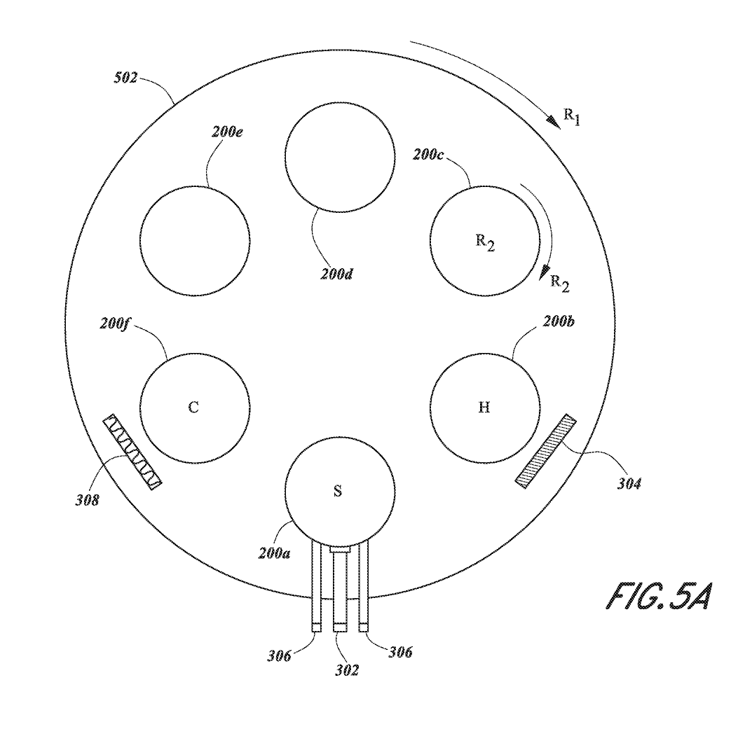

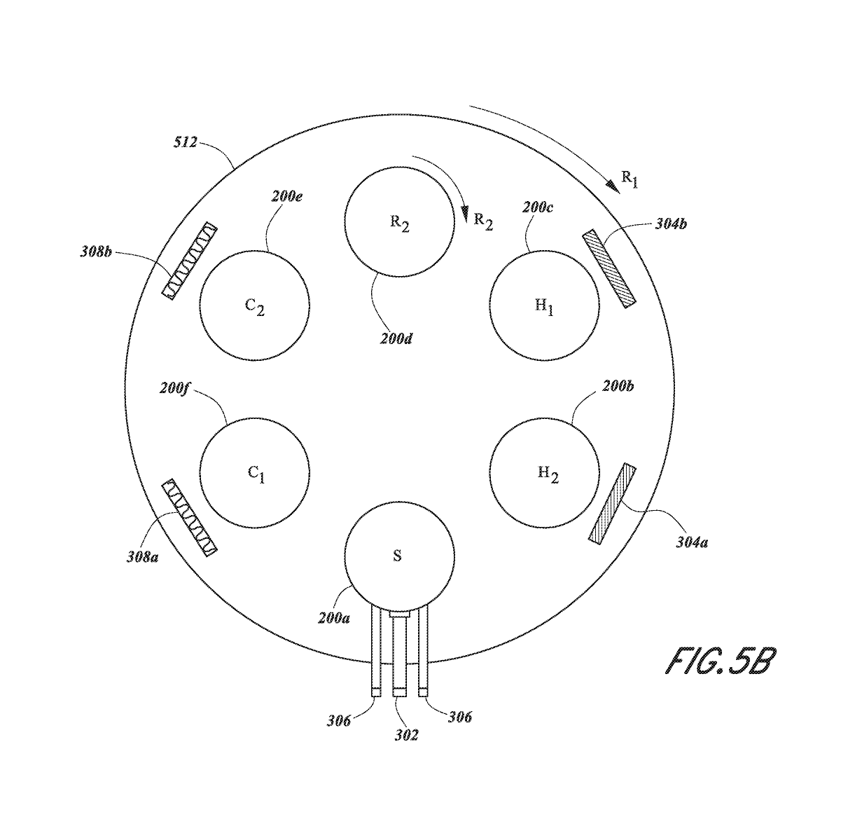

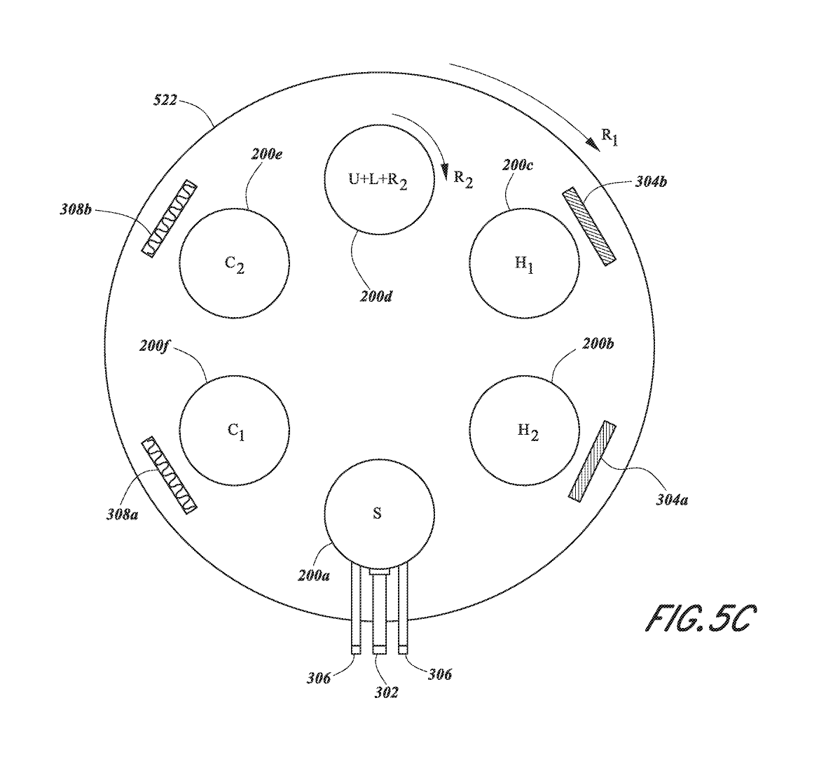

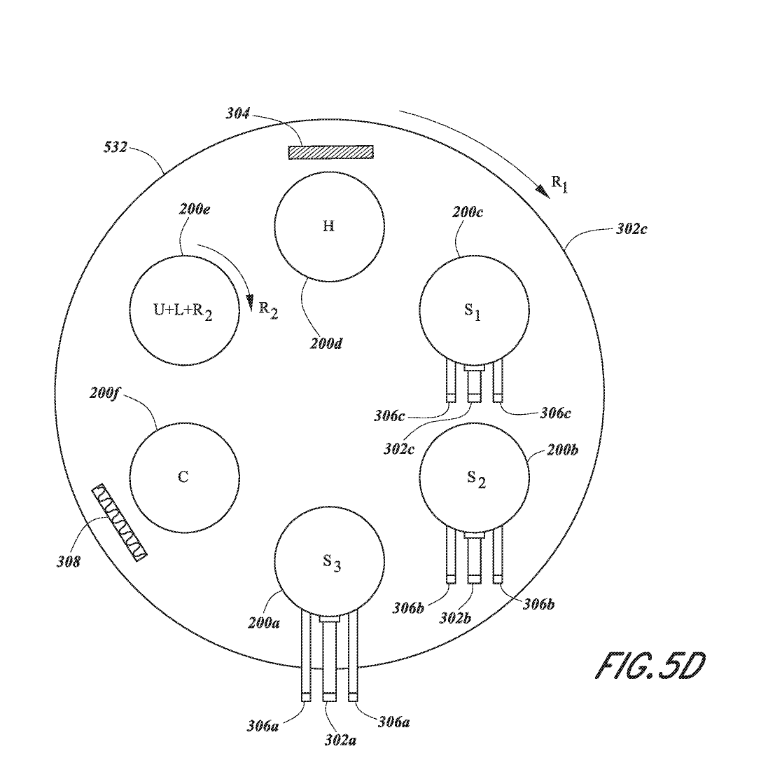

FIG. 5A is a front perspective view of a rapid manufacturing mandrel system with the stamp, the cooling system, and the heat pad on different positions of the mandrel system according to some embodiments. Here, the heating pad 304 is heating a bucket on a mandrel 200B while the stamp 302 is stamping another bucket on a different mandrel 200A. The cooling system is cooling another bucket on mandrel 200F. This type of configuration may further save time. An estimate of the time it may take the rapid manufacturing mandrel system 502 to stamp six buckets 200A-200F by the embodiment in FIG. 5 may be:

L+H+(the greater of 5H, 5S, 5C, R₂)+S+C+U+6R₁+R₂

This is because all six buckets 200A-200F may be loaded at the same time reducing the loading and unloading times to (L+U). The first bucket 200A-200F on mandrel 200F may be heated by the heating pad 304 (H). The rapid manufacturing mandrel system 502 may rotate, placing the mandrel 200F adjacent to the supports 306 and the stamp 302, and placing the mandrel 200A adjacent to the heating pad 304. Then, the bucket on the mandrel 200F may be supported by the supports 306 and stamped by the stamp 302, simultaneously while the bucket on mandrel 200A is heated by the heating pad 304. Because of this simultaneous action, the time is reduced as compared to the embodiment of FIG. 4A, where heating and stamping is conducted on the same position of the rapid manufacturing mandrel system 502 and has to be done serially. The amount of time reduced depends on whether the heating or stamping takes the longer amount of time, because the rapid manufacturing mandrel system 502 will not rotate until the heating and stamping are both complete (the greater of 5H or 5S).

The rapid manufacturing mandrel system 502 may rotate, positioning the bucket on the mandrel 200F on the cooling pad 308, positioning the bucket on the mandrel 200A on the stamp, and positioning the bucket on the mandrel 200B on the heat pad 304. Accordingly, further time is saved because a first bucket can be heated, a second bucket can be stamped, and a third bucket can be cooled simultaneously. The time reduced depends on whether the heating, stamping, or cooling takes the longer amount of time, because the rapid manufacturing mandrel system 502 will not rotate until the heating, stamping, and cooling are complete (the greater of 5H, 5S, 5C).

In some embodiments, a fourth bucket is rotated to align with the heat pad, the stamp, and/or the cooling system simultaneously to the first bucket heated, the second bucket stamped, and a third bucket cooled. Accordingly, further time is saved because four functions of the mandrel system can be performed at the same time. The time reduced depends on whether the heating, stamping, cooling, or rotating takes the longer amount of time, because the rapid manufacturing mandrel system 502 will not rotate until the heating, stamping, cooling, and rotating are complete (the greater of 5H, 5S, 5C, R₁).

The rapid manufacturing mandrel system 502 can stamp the last mandrel (e.g. mandrel 200A (S)). In some embodiments, the mandrel system may not require the rotation of the individual mandrels 200A-200F themselves. The bucket may not need to be rotated at all. For example, the heating, stamping, and cooling may be applied to the same area of the bucket by the rotation of the mandrel system R₁. In some embodiments, the bucket is rotated initially R₂, then the focused portion is locked in place while the mandrel system is rotated R₁, such that the heating, stamping, and cooling is applied to the same location on the bucket. Thus the individual mandrel rotation time is saved. In this embodiment, the rapid manufacturing mandrel system 502 rotates R₁ 6 times to get all buckets heated and stamped.

FIG. 5B is a front perspective view of a rapid manufacturing mandrel system with two heat pads and two cooling systems on different positions of the mandrel system according to some embodiments. In this embodiment, one bucket is rotated on mandrel 200D (R₁). Simultaneously, the bucket on mandrel 200C is heated by heat pad 304B (H₁), the bucket on mandrel 200B is also heated by another heat pad 304A (H₂), the bucket on mandrel 200A is stamped by the stamp 302 (S), the bucket on mandrel 200F is cooled by cooling system 308A (C₁), and the bucket on mandrel 200E is also cooled by cooling system 308B (C₂). An estimate of the time it may take the rapid manufacturing mandrel system 512 to stamp six buckets 200A-200F by the embodiment in FIG. 5 may be:

L+H₁+H₂+(the greater of 5H₁, 5H₂, 5S, 5C₁, 5C₂, R₂)+S+C₁+C₂+U+6R₁+R₂

This embodiment may be useful if the heating (H) and cooling (C) process take the most amount of time. For example, in this scenario, using the mandrel system of FIG. 5B, the estimated time is:

L+H+(the greater of 5H, 5S, 5C, R₂)+S+C+U+6R₁+R₂

where because H and C are the largest, the estimated time for (the greater of 5H, 5S, 5C, R₂) in the time estimation will consistently be either 5H or 5C.

In the embodiment of FIG. 5B, the heating and cooling process is segmented into two separate steps. Accordingly, the amount of time a bucket is placed in a position on the mandrel system may be reduced. For example, the heating and cooling process may take 5 units of time each under the embodiment of FIG. 5A. However, the heating and cooling process may take 3 units of time under the embodiment of FIG. 5B (e.g. each bucket is heated twice under 3 units of time, and cooled twice under 3 units of time). Accordingly, the embodiment of FIG. 5B may require that the bucket be placed at a position of the mandrel system (e.g. 200C, 200B) for shorter lengths of time each.

FIG. 5C is a front perspective view of a rapid manufacturing mandrel system where the bucket is fed and removed at a single position according to some embodiments. In the embodiment of FIG. 5C, the bucket may be fed and removed from the mandrel at a single position. For example, the bucket may be fed at mandrel 200D, rotated at mandrel 200D, moved to mandrel 200C and 200D to be heated by heating pads 304B and 304A respectively, stamped at stamp 302 on mandrel 200A, cooled on mandrel 200F and 200E by cooling systems 308A and 308B, and removed from the mandrel at mandrel 200D. This can be a circular pattern, such that the load and unload time can be reduced because it will be occurring at the same time as the heating, stamping, cooling, and/or rotating. For example, in this scenario, using the mandrel system of FIG. 5B, the estimated time for a single mandrel will be:

[greater of H₁, H₂, S, C₁, C₂, (L+R₂+U)]+R₁

Under this scenario, not all 6 buckets have to go through each step to produce a completed bucket. In this embodiment, with each rotation of the mandrel system R₁, a bucket is unloaded. Accordingly, the time for each bucket can be greatly reduced by having many steps performed in parallel.

FIG. 5D is a front perspective view of a rapid manufacturing mandrel system where multiple stamps are applied according to some embodiments. In some embodiments, multiple stamps can be applied to the bucket. For example, in the embodiment of FIG. 5D, multiple functions occur simultaneously:

1. a first bucket is unloaded at mandrel 200E and a second bucket is subsequently loaded and rotated onto the mandrel system

2. a third bucket is heated by the heating pad 304 at mandrel 200D

3. a fourth bucket is stamped by stamp 302C on mandrel 200C

4. a fifth bucket is stamped a second time by stamp 302B on mandrel 200B

5. a sixth bucket is stamped a third time by stamp 302A on mandrel 200A

6. a seventh bucket is cooled by cooling system 308 on mandrel 200F

The first, second, and third stamp may include stamping a design, a shield, a protective layer, the same or similar design to reinforce its attributes (e.g. to make the design more resistant to wear and tear, to create a brighter color), and the like. For example, the first stamp may include stamping a design. The second stamp may include stamping a shield over the design. The third stamp may include stamping a protective covering over the shield and the design.

In some embodiments, heating, cooling, and rotating steps may be included in between the stamping. For example, between each stamp, the mandrel system may heat and cool the portion of the bucket. In another example, between each stamp, the mandrel system may rotate the bucket such that the second stamp stamps a different portion of the bucket than the first stamp.

The rotation of the bucket at mandrel 200E is an optional, such that the rotation may not be needed to align for cooling, stamping, and heating. In some embodiments, rotation occurs before one or each of the steps for cooling, stamping, and heating.

Other embodiments of rapid manufacturing are appreciated. There may be a plurality of heating pads 304, supports 306 and stamps 302, different number of mandrels 200A-200F, different type of rotation or movement by the rapid manufacturing mandrel system (for example may move in a linear fashion such as in a conveyor belt), or the rapid manufacturing mandrel system may be larger or smaller relative to the size of the mandrels 200A-200F.

### Multipurpose Lid

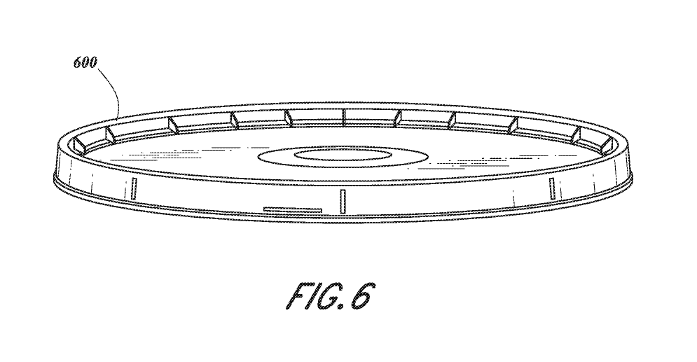

Bucket lids can also be manufactured by the rapid manufactured disclosed in any embodiments described in this disclosure. Even though people may sit on bucket lids, the lids are generally made of hard plastic and are uncomfortable. FIG. 6 is a perspective view of a conventional lid for a bucket. This bucket lid has a top that is recessed below with grooves along the edges. The recess and the grooves make sitting on the lids uncomfortable. Even with the buckets overturned, the seat is uncomfortable. Thus, there is a need to create bucket lids that are better suited for seating. Furthermore, placing items on top of the lid may lead to disorganization or falling off the bucket in certain circumstances, such as if the bucket is being transported. Therefore, there is a need to create a bucket that will hold tools and items in place. Additionally, because bucket nesting, lid nesting, and lid stacking are an important part of storage and transportation, a bucket lid with a seat that allows for such nesting and stacking is desired.

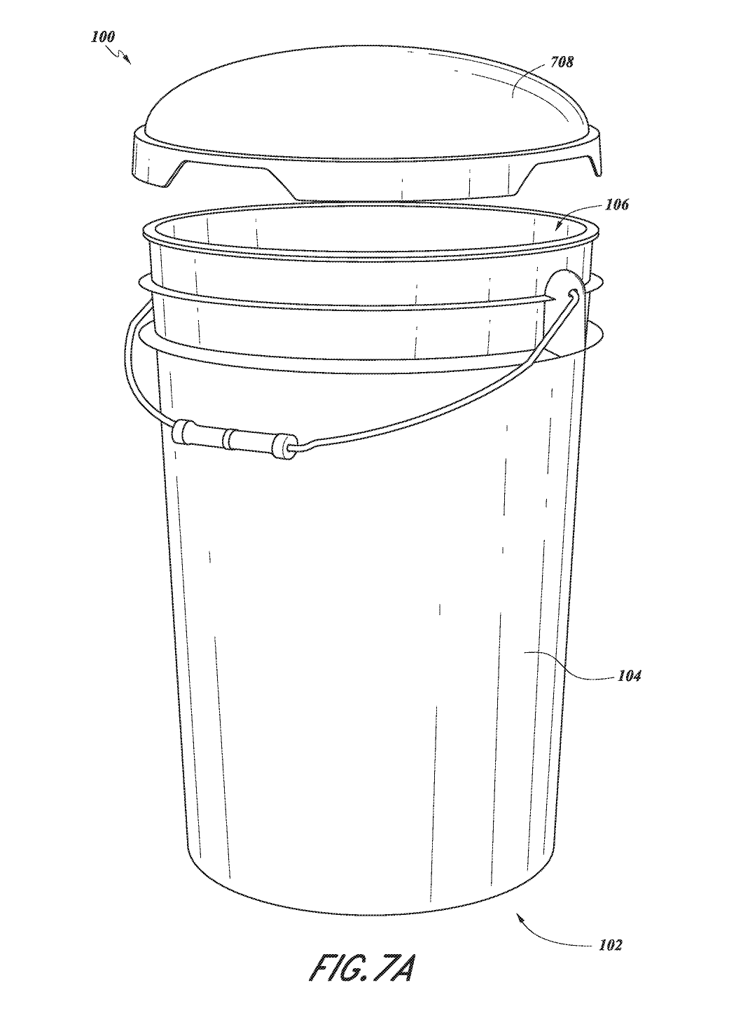

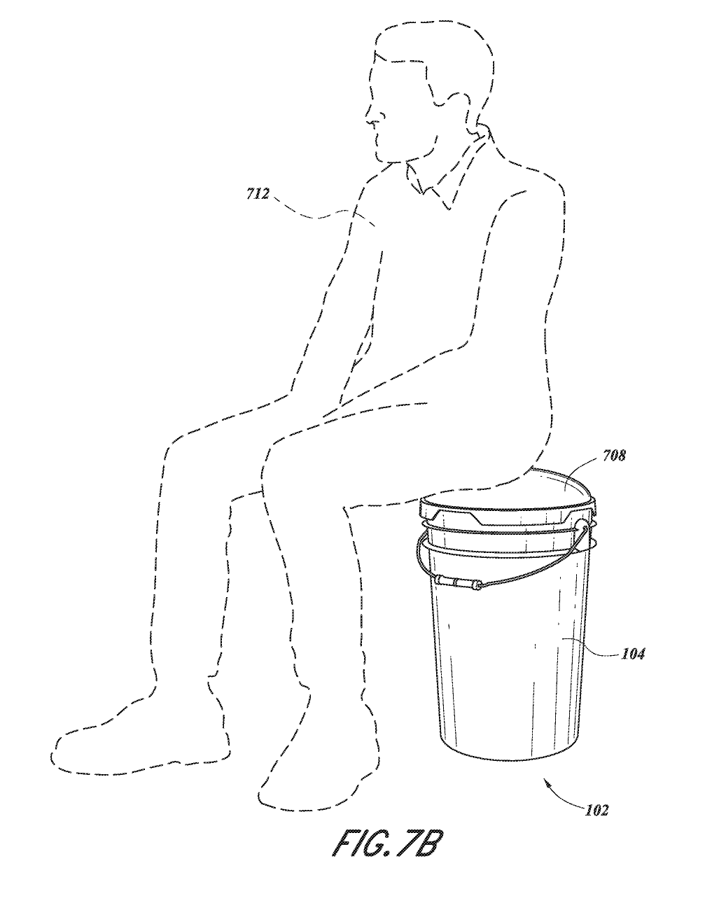

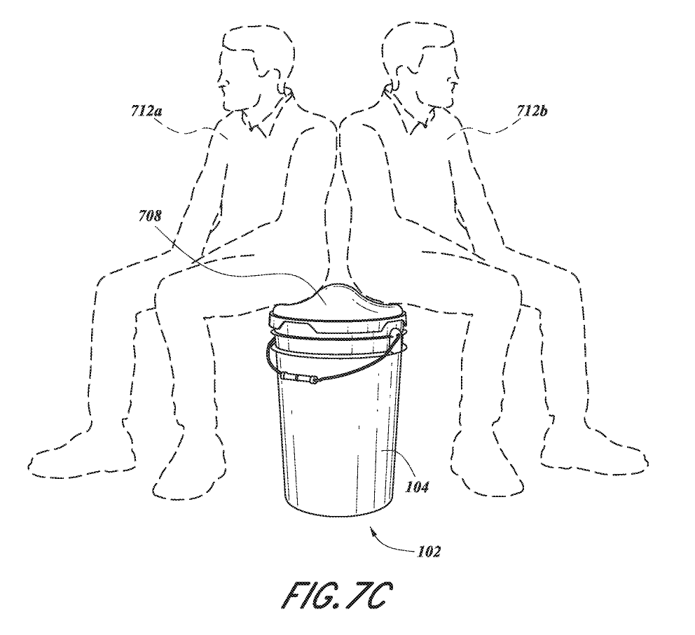

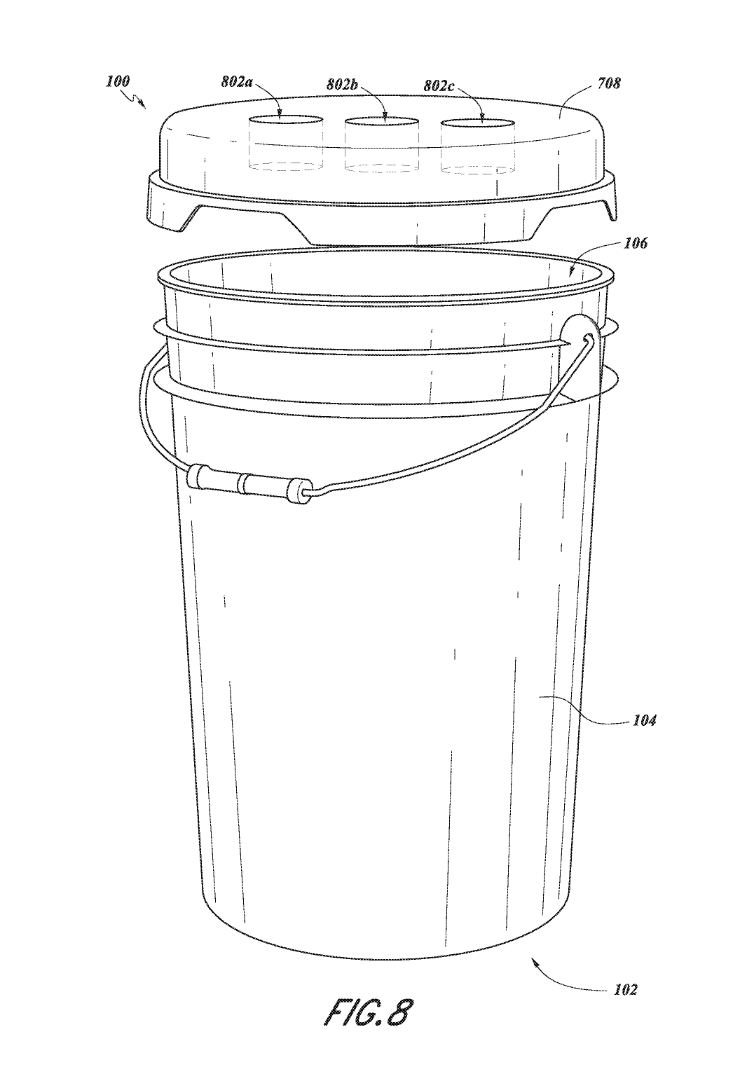

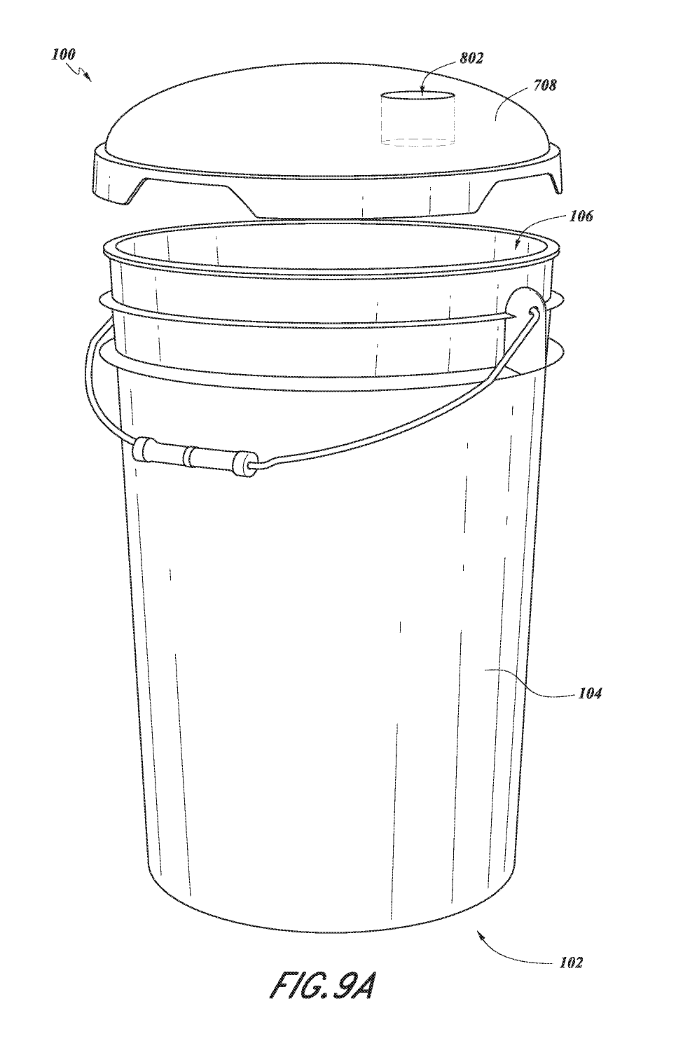

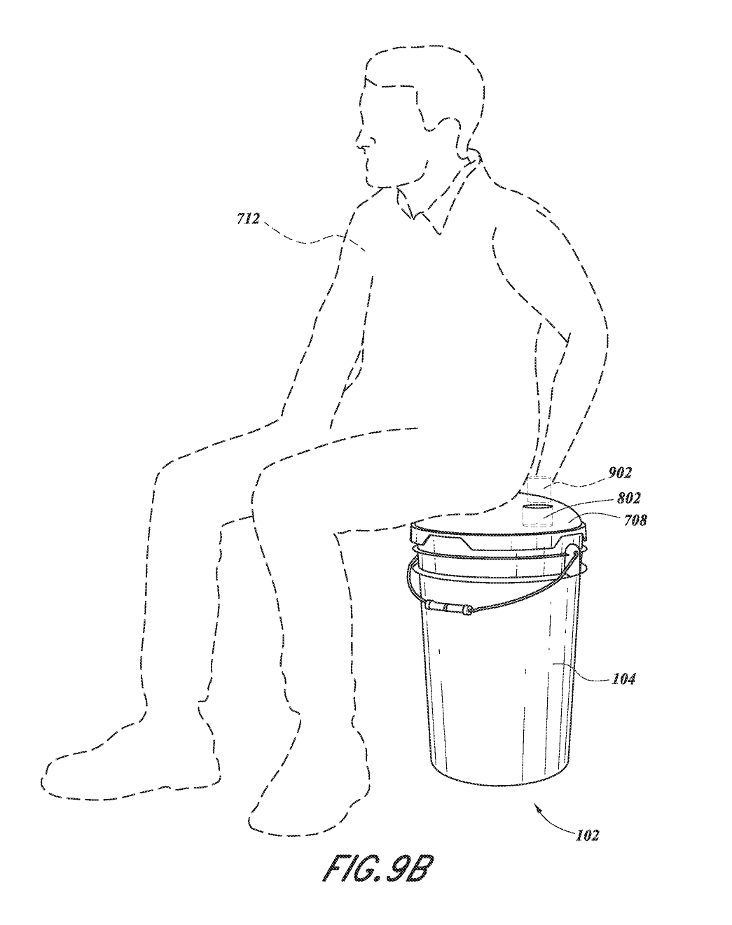

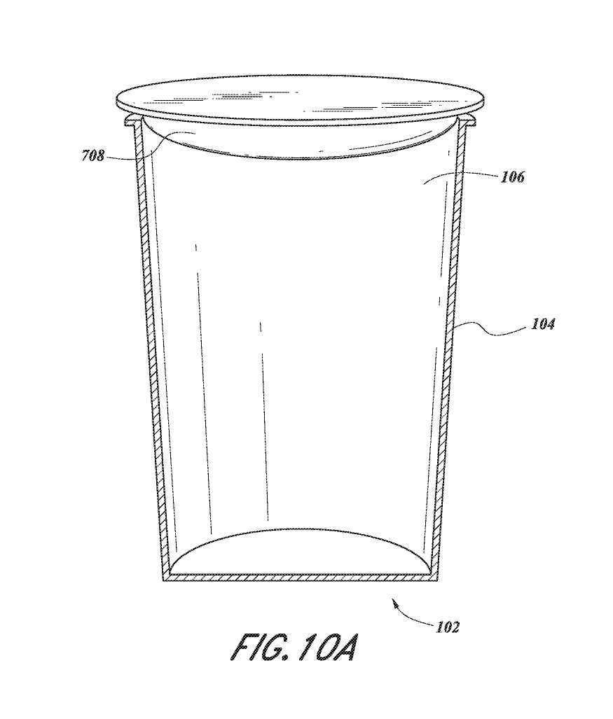

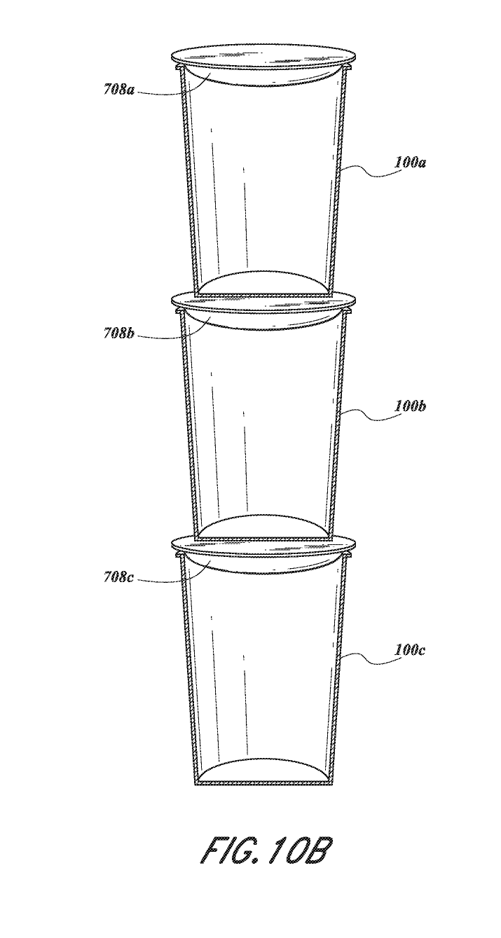

Turning now to the Figures where like numbers represent like elements, FIGS. 7-10 illustrate several views of the bucket with the multi-purpose lid. FIG. 7A is a first front perspective view of a bucket with a lid that serves as a seat according to some embodiments. FIG. 7B is a front perspective view of a bucket with an individual sitting on the lid according to some embodiments. FIG. 8 is a second front perspective view of the bucket with a lid that can be used to hold items according to some embodiments. FIG. 9A is a front perspective view of the bucket with a lid that can be partially used as a seat and partially used to hold items according to some embodiments. FIG. 9B is a front perspective view of an individual sitting on the lid and placing items into slots on the lid according to some embodiments. FIG. 10A is a cross-sectional view of the bucket with the reversible lid according to some embodiments. FIG. 10B is a cross-sectional view of buckets stacked on top of the reversible lid according to some embodiments.

The bucket 100 can be made of a variety of different materials and from different processes. For example, the bucket 100 can be made from one or more of: recycled Polypropylene feedstocks, clarified polypropylene, impact resistant modified polypropylene (e.g., synthetic rubber, metalecines, EVA, elastomers, etc.), plant-based polymers, thermal plastics, and high density polyethylene (HDPE) for low temperature impact performance. HDPE has the advantage of being inert and therefore compatible with a variety of compounds. Thus, testing of compatibility with HDPE may be reduced or avoided. HDPE is also reasonably priced.

The bucket 100 can be made by co-injection technology to incorporate recycle feedstock as a multi-layer structure. One aspect of co-injection technology is where two or more individual melt streams unite to make a single article or material. The co-injection technology can be used to apply gas barrier materials in a multi-layer composition. The bucket 100 can also be produced by over molding, which is an injection molding process where one material is molded onto a second material. A variety of surface treatments can be applied to the surface of the bucket 100. For example, one or more surfaces of the bucket 100 can be plasma treated to enhance gas barrier properties.

For example, in some embodiments, the bucket 100 (or portions thereof) can provide some protection from physical damage, such as scratches or dents, water damage, and/or damage resulting from electromagnetic waves. In certain embodiments, the bucket 100 (or a portion thereof) can be made from a plastic, metallic, rubber, wood, leather, copper, gloss, snake leather, and/or waterproof, sound absorbing, soundproof, sound reflecting, and/or electromagnetic wave insulating material. In certain embodiments, the bucket 100 or a portion thereof can be made of a flexible material as to allow easy installation and/or removal. In some embodiments, the bucket 100 or a portion thereof can be made a rigid or substantially rigid material.

As illustrated in FIG. 7A, the bucket 100 may include a lid 708. In FIG. 7A, the diameter of the lid 708 is generally similar to the diameter of the side wall portion 104 of the bucket 100. However, other designs of the lid 708 in relation to the bucket 100 are appreciated. For example, the outer circumference of the lid 708 may be the same as the inner circumference of the top area 106 of the bucket 100. The lid 708 may be snap fit, fastened, or attached to the bucket 100, and configured to allow the lid to be detached from the bucket 100. The lid 708 can be universal to fit standard or custom buckets 100.

The lid 708 may be a completely separate piece from the bucket 100 or may be a part of the bucket 100 that can be moved in a way to create a closing member for the bucket 100. The lid may be any closing member of the opening in the bucket 100. For example, the lid 708 may close a portion of the bucket 100 and/or may close several openings for the bucket 100. The lid 708 may be detached from the opening of the bucket 100 but may be attached to the bucket in another way (e.g. a string connected to the lid 708 and the bucket 100).

As shown in FIG. 7A, the lid 708 can serve as a seat. In this example, the lid 708 has a cushion surface that is the shape of a semisphere that extends the diameter of the side wall portion 104. However, other shapes of the lid 708 are recognized. For example, the lid can be of a smaller diameter, can be more flat or other shaped, can be multiple semi-spheres or multiple shapes, can be a semi-sphere that sticks out more or less, can be in the shape of a person's buttocks, etc.

The lid 708 can serve as a seat while placed on the top area of the bucket 100. The lid 708 may also serve as a seat by itself without the bucket 100.

The lid 708 can be manufactured in a variety of ways. One way is for the lid 708 to be integrated or as an insert. The lid 708 can be injection molded and inserted into an injection mold where a soft material can be molded over the lid. For example, the lid can be over molded where a softer material fit for seating is molded onto a harder material to create the firm structure for the bucket lid.

The lid 708 may comprise of several mixes of different materials. For example, the lid 708 may have a covered fabric that may make the seat a different characteristic, such has making it softer. The lid 708 alternatively can be a single piece of material or a single mix of materials. The lid may be the substrate for the seat. The seat pad and contour may be molded or adhered to the substrate made of structural foam, polyurethane, PVC, elastomers or any durable soft thermoplastic or thermoset.

The lid 708 may comprise handles, holes, loops, strips, and other physical characteristics that make the lid 708 functions better as a lid or a seat.

The lid 708 in FIG. 7A may have a skirt around the lid that helps to attach the lid 708 to the bucket 100. The lid 708 may be secured onto the bucket 100 in a variety of different ways. For example, the lid 708 may be snapped onto the bucket 100, the lid 708 and the bucket 100 may have corresponding threading and ridges to turn the lid 708 onto the bucket 100, or there may be hinges or arms extending out from the lid 708 and/or the bucket 100 that help fasten the two together.

The lid 708 in FIG. 7A provides seating in full 360 degrees. However, it is recognized that the seats can be available for a partial degree, or a partial area. This may allow for utility of the other areas, or alternatively, provide for more seats.

Although the lid 708 FIG. 7A has a determined thickness based on the diameter semisphere, it is recognized that the lid's thickness may be reduced to save space in storage or adjusted to provide customization of the seat. The thickness may be determined by the seat design and materials. In some cases, the lid may be designed where the seat can be inverted so it is on the inside of the bucket for transport or to keep it clean.

A living hinge may be molded onto an article where the container and lid may be molded together in the same tool. A living hinge may include a thin flexible hinge (flexure bearing) made from the same material as the two rigid pieces it connects, rather than cloth, leather, or some other flexible substance, which is able to bend numerous times without breaking or separation.

FIG. 7B is a front perspective view of a bucket with an individual sitting on the lid according to some embodiments. The individual 712 may place his buttocks on the seat portion of the lid 708. The seat portion of the lid 708 may be made of a soft cushion such as to form at least to a portion of the shape of the buttocks when the individual 712 sits on the seat portion of the lid 708. In some embodiments, the seat portion of the lid 708 may be in a shape that is comfortable for seating.

FIG. 7C is a front perspective view of a bucket with multiple individuals sitting on the lid according to some embodiments. The seat portion of the lid 708 may be in an inverted semicircle shape. The seat portion of the lid 708 may be formed to seat multiple individuals. For example, individual 712A may sit on one seat portion of the lid 708, where another individual 712B may sit on another seat portion of the lid 708.

FIG. 8 is a second front perspective view of the bucket with a lid that can be used to hold items according to some embodiments. The lid 708 can be molded to hold items into slots 202 that can be customized for certain items, such as specific tools, drinks, or containers.

The slots 202 can be a variety of different shapes, such as semi-spherical, rectangular, cylindrical, etc. The slots 202 can be an opening or can have an open/close position, such as having a hinged door or pulling a shelf. The slots can be big, small, wide, narrow, symmetrical, asymmetrical, fit a standard size, or be customized. The slot 202 can be a dispenser or pump receptacle.

In some embodiments, the slots may be configurable in size and shape. For example, the radius of the slots may be increased or decreased. In the embodiment of FIG. 8, the lid 708 is of a rectangular shape. However, it is appreciated that the lid 708 may be of other shapes, such as semicircular, triangular, and the like.

FIG. 9A is a third front perspective view of the bucket with a lid that can be partially used as a seat and partially used to hold items according to some embodiments. Although FIG. 9A shows generally half of the lid 708 usable as a seat and a single slot 202 on the other end of the lid 708, many other types of combinations are recognized.

FIG. 9B is a front perspective view of an individual sitting on the lid and placing items into slots on the lid according to some embodiments. The individual 712 may be sitting on the left side of the lid and placing a beverage 902 into the slot 802 of the lid 708.

FIG. 10A is a cross-sectional view of the bucket with the reversible lid according to some embodiments. In FIG. 10A, the lid 708 is reversed and place on the top area 106 of the bucket 100. Because of the reversed configuration of the lid 708, the seating area of the lid is inserted first into the top area 106 of the bucket 100. In this embodiment, the lid 708 may be reversible and may be fastened onto the bucket 100 on both sides.

This reversible lid 708 is advantageous because it allows for bucket stacking. There may be some embodiments that do not allow for effective stacking if the lid 708 is not reversed. For example, there may be an embodiment where the seating portion of the lid 708 protrudes too much, that when a second bucket 100 is placed on top of the lid 708 of first bucket, the second bucket 100 may fall off because of the non-flat contour surface of the seating area of the lid 708.

However, it is appreciated that even without the lid 708 reversed, that the buckets may be stacked. For example, the bottom portion 102 of the bucket 100 may be indented in a way that allows for effective stacking of the bucket 100. For example, the bottom portion 102 of the bucket 100 may fit the contour of the seat portion of the lid 708. Then the bottom portion 102 of a second bucket 100 may be adjacent to the seating portion of the lid 708 and fit for stacking. Furthermore, the bottom portion of the lid 708 may also be configured to fit contour of the seat portion of the lid 708. This may allow for stacking of the lids 708 as well.

FIG. 10B is a cross-sectional view of buckets stacked on top of the reversible lid according to some embodiments. In this embodiment, a first bucket 100A is stacked on top of a reversible lid 708B and a second bucket 100B, which is stacked on top of a reversible lid 708C and a third bucket 100C.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

1. A method for creating a detail on receptacles using a stamp of a mandrel system, the method comprising:
loading, by the mandrel system, a first receptacle onto a first mandrel of the mandrel system;
aligning, by an actuator of the mandrel system, the first receptacle with a heat pad such that desired portion of the first receptacle can be heated by the heat pad;
heating, by the heat pad of the mandrel system, the desired portion of the first receptacle, wherein material of the heated portion of the first receptacle softens;
stamping, by a stamp of the mandrel system, at least a subset of the heated portion of the first receptacle; and
cooling, by a cooling system of the mandrel system, at least a subset of the stamped portion of the first receptacle, wherein during at least one of the aligning, heating, stamping, or cooling of the first receptacle, a second receptacle on a second mandrel of the mandrel system is simultaneously aligning, heating, stamping, or cooling.

2. The method of claim 1, wherein the first and second receptacle are loaded into the first and second mandrel simultaneously.

3. The method of claim 1, wherein the first receptacle is loaded into the first mandrel while the second receptacle that is already loaded onto the second mandrel is simultaneously being aligned, heated, stamped, or cooled.

4. The method of claim 1, wherein aligning, by an actuator of the mandrel system, the first receptacle with a heat pad such that desired portion of the first receptacle can be heated by the heat pad includes rotating the first mandrel such that the rotated position of the first mandrel allows the heating pad to heat the desired portion of the first receptacle.

5. The method of claim 1, wherein aligning, by an actuator of the mandrel system, the first receptacle with a heat pad such that desired portion of the first receptacle can be heated by the heat pad, heating, by the heat pad of the mandrel system, the desired portion of the first receptacle, wherein material of the heated portion of the first receptacle softens, stamping, by a stamp of the mandrel system, at least a subset of the heated portion of the first receptacle, and cooling, by a cooling system of the mandrel system, at least a subset of the stamped portion of the first receptacle occurs at a single position on the mandrel system.

6. The method of claim 1, wherein at least two of aligning, by an actuator of the mandrel system, the first receptacle with a heat pad such that desired portion of the first receptacle can be heated by the heat pad, heating, by the heat pad of the mandrel system, the desired portion of the first receptacle, wherein material of the heated portion of the first receptacle softens, stamping, by a stamp of the mandrel system, at least a subset of the heated portion of the first receptacle, or cooling, by a cooling system of the mandrel system, at least a subset of the stamped portion of the first receptacle occurs at different positions on the mandrel system.

7. The method of claim 1, further comprising:
before stamping, by a stamp of the mandrel system, at least a subset of the heated portion of the first receptacle, rotating the mandrel system such that the first mandrel moves from a position for heating by the heating pad of the mandrel system to a position for stamping by the stamp of the mandrel system; and
before cooling, by a cooling system of the mandrel system, at least a subset of the stamped portion of the first receptacle, rotating the mandrel system such that the first mandrel moves from a position for stamping by the stamp of the mandrel system to a position for cooling by the cooling system of the mandrel system.

8. The method of claim 1, wherein the first mandrel is configured such that a draw exists between the first receptacle and the first mandrel when the first receptacle is placed on the first mandrel of the mandrel system such that an air gap is formed, and wherein the first mandrel includes a vacuum configured to extract gas between the first mandrel and the first receptacle.

9. The method of claim 1, wherein stamping, by a stamp of the mandrel system, at least a subset of the heated portion of the first receptacle includes stamping the at least a subset of the heated portion of the first receptacle such that the at least a subset of the heated portion of the first receptacle is substantially flush to another portion of the first receptacle.

10. A mandrel system for stamping receptacles using concurrent processing, the mandrel system comprising:
a first mandrel configured to:
load and unload a first receptacle; and
move to at least two positions of the mandrel system;
a second mandrel configured to:
load and unload a second receptacle; and
move to the at least two positions of the mandrel system;
a heat pad configured to heat a portion of the first and second receptacle, wherein material of the heated portion of the first and the second receptacle softens;
a stamp configured to stamp at least a subset of the heated portion of the first and second receptacle; and
a cooling system configured to cool at least a subset of the stamped portion of the first and second receptacle;
wherein the first mandrel is configured to be disposed at a first position of the mandrel system while the second mandrel is configured to be disposed at a second position of the mandrel system;
wherein at least two of the heat pad, the stamp, or the cooling system are positioned in substantial proximity of the first position and second position of the mandrel system, respectively.

11. The mandrel system of claim 10, wherein the heat pad includes a first heat pad and a second heat pad disposed at different positions of the mandrel system.

12. The mandrel system of claim 10, wherein the cooling system includes a first cooling system and a second cooling system disposed at different positions of the mandrel system.

13. The mandrel system of claim 10, wherein the stamp includes a first stamp configured to stamp a design and a second stamp configured to stamp a shield, the first and second stamp disposed at different positions of the mandrel system.

14. The mandrel system of claim 10, wherein the first receptacle is unloaded on a first position of the mandrel system, and a second receptacle is loaded onto the first position of the mandrel system.

15. The mandrel system of claim 10, wherein the cooling system of the mandrel system is configured to transfer heat by changing a temperature of at least a portion of a mandrel.

16. The mandrel system of claim 10, further comprising a support structure configured to support the first receptacle for stamping, by a stamp of the mandrel system, the at least a subset of the heated portion of the first receptacle.

17. A reversible lid for a receptacle, the reversible lid comprising:
a bottom portion configured to support receptacle stacking such that another receptacle can stack on the bottom portion when the reversible lid is fastened to the receptacle where the bottom portion is facing away from the receptacle;
a top portion; and
a fastening mechanism is configured to fasten the reversible lid to the receptacle in at least two configurations: where the bottom portion is facing away from the receptacle and where the bottom portion is facing toward the receptacle.

18. The reversible lid for a receptacle of claim 17, wherein the top portion includes one or more slots integrated with the top portion and configured to hold objects in the one or more slots.

19. The reversible lid for a receptacle of claim 17, wherein top portion is a substantially semispherical shape and includes material softer than the material of the bottom portion, wherein the top portion provide a seat for an individual.

20. The reversible lid for a receptacle of claim 17, wherein at least a portion of the reversible lid is created by co-injection technology.
